(19) United States
(12) Patent Application Publication
(10) Pub. No.: US 2003/0170349 A1
(43) Pub. Date: Sep. 11, 2003

(54) Ice cream burger and method of preparing the same

(76) Inventor: Young Jik Lee, Choongchungbuk-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/365,707

(22) Filed: Feb. 10, 2003

(30) Foreign Application Priority Data
Feb. 9, 2002 (KR) 2002/7787

(51) Int. Cl. A23L 1/31

(52) U.S. Cl. 426/101

(57) ABSTRACT

Disclosed are an ice cream burger and a method of making the same. The ice cream burger includes a pair of bread pieces; a cooked meat patty placed between the pair of bread pieces; and at least one layer of ice cream placed between the pair of bread pieces. The cooked meat patty is made of a meat component and other substances. The method of preparing an ice cream burger includes: providing a cooked meat patty; providing a pair of bread pieces; providing at least one layer of ice cream; and sandwiching the cooked meat patty and the at least one ice cream layer with the bread pieces, thereby providing an ice cream burger. Making the cooked meat patty includes providing ground meat; mixing the ground meat with one or more non-meat substances; shaping the resulting mixture into a raw meat patty; and cooking the raw meat patty to provide a cooked meat patty.

### BACKGROUND OF THE INVENTION

The present invention relates to instant food technology. More particularly, the present invention relates to an ice cream burger and a method of making the ice cream burger.

Hamburgers and ice cream are completely different types of food. Hamburgers are a main dish in a meal although it is normally considered as a fast food meal. Hamburgers are generally served warm. On the other hand, ice cream is a cold dessert. Generally, people do not have hamburgers and ice cream simultaneously. It is not only because of their functional differences but also because meat of hamburgers and ice cream may not be in harmony in terms of taste and feeling. There are some ice cream products, where ice cream is sandwiched with cookies or bread. There has not been a report of product with meat and ice cream.

### SUMMARY OF THE INVENTION

The present inventor has made an effort to develop a method for effectively harmonizing the taste of hamburger with ice cream, and prepared ice cream burger in which meat is matched with ice cream in terms of taste and feeling, by employing a patty for burger obtained by ripening a meat with wine and refined salt.

An aspect of the present invention provides an ice cream burger. The ice cream burger comprises: a pair of bread pieces; a cooked meat patty placed between the pair of bread pieces; and at least one layer of ice cream placed between the pair of bread pieces. In the ice cream burger, one layer of the ice cream is placed between the cooked meat patty and either of the pair of bread pieces. Two layers of the ice cream are placed on both sides of the cooked meat patty. The at least one layer of the ice cream comprises one or more sublayers of ice cream, and wherein neighboring sublayers are of different kinds of ice cream. The neighboring sublayers of the ice cream are of different colors.

The above-described ice cream burger further comprises one or more layers of flavoring materials selected from the group consisting of fruit flavored syrup, caramel syrup and chocolate syrup, wherein the one or more flavoring layers are placed between the pair of bread pieces. The bread pieces are hamburger buns or sandwich bread. The meat patty comprises one or more meat components selected from the group consisting of beef, pork, chicken, turkey and lamb. The meat patty has a thickness from about 0.5 cm to about 2 cm. Each ice cream layer has a thickness from about 0.5 cm to about 3.5 cm. Each ice cream layer has a thickness from about 1.5 cm to about 2.5 cm.

In the above ice cream burger of claim 1, the meat patty comprises a saccharide and carrageenan. The meat patty comprises one or more substances selected from the group consisting of saccharides, polysaccharides, agar gum, guar gum, locust bean gum, carrageenan, tara gum, gum arabic, ghatti gum, Khayagrandifolia gum, tragacanth gum, and karaya gum. The meat patty comprises one or more substances selected from the group consisting of saccharides, polysaccharides, powdered cookie, bread crumb, powdered skim milk, soybean protein, fructose, starch, sugar alcohol, sweetened condensed milk, carrageenan and mulberry leave powder.

The meat patty comprises at least one meat component from about 5 wt % to about 40 wt % with reference to the total weight of the meat patty. The meat patty comprises powdered cookie or bread crumb from about 20 wt % to about 50 wt % with reference to the total weight of the meat patty. The meat patty comprises powdered skim milk from about 0.001 wt % to about 25 wt % with reference to the total weight of the meat patty. The meat patty comprises soybean protein from about 0.001 wt % to about 30 wt % with reference to the total weight of the meat patty. The meat patty comprises fructose from about 5 wt % to about 25 wt % with reference to the total weight of the meat patty. The meat patty comprises starch or sugar alcohol from about 0.001 wt % to about 20 wt % with reference to the total weight of the meat patty. The meat patty comprises sweetened condensed milk from about 5 wt % to about 30 wt % with reference to the total weight of the meat patty. The meat patty comprises carrageenan from about 0.001 to about 2 wt % with reference to the total weight of the meat patty. The meat patty comprises mulberry leave powder from about 0.001 wt % to about 2 wt % with reference to the total weight of the meat patty.

Another aspect of the present invention provides a method of preparing an ice cream burger. The method comprises: providing a cooked meat patty; providing a pair of bread pieces; providing at least one layer of ice cream; and sandwiching the cooked meat patty and the at least one ice cream layer with the bread pieces, thereby providing an ice cream burger. In the method, the provision of the at lest one ice cream layer comprises forming at least one layer of ice cream on either side of the bread pieces. The provision of the at lest one ice cream layer comprises forming at least one layer of ice cream on either side of the cooked meat patty. The method further comprises forming at least one flavoring layer with one or more flavoring materials selected from the group consisting of fruit flavored syrup, caramel syrup and chocolate syrup, and wherein the flavoring layer is formed before the sandwiching. The method further comprises freezing the ice cream burger, which is carried out at a temperature below about −30° C.

In the above-described method, the provision of the cooked meat patty comprises: providing ground meat; mixing the ground meat with one or more substances selected from the group consisting of saccharide, polysaccharides, powdered cookie, bread crumb, powdered skim milk, soybean protein, fructose, starch, sweetened condensed milk, carrageenan and mulberry leave powder; shaping the resulting mixture into a raw meat patty; and cooking the raw meat patty to provide a cooked meat patty. The method further comprises aging the ground meat for a period from about 30 minutes to about 3 hours before the mixing with the one or more substances. The method further comprises adding wine and salt to the ground meat before the mixing with the one or more substances. The cooking the raw meat patty is carried out with use of a method selected from the group consisting of high-temperature sterilization, high-pressure sterilization, pasteurization and high-temperature/high-pressure sterilization. The cooking the raw meat patty comprises steaming the raw meat patty at a temperature from about 100° C. to about 130° C. The cooking the raw meat patty comprises steaming the raw meat patty at a pressure from about 1 atm to about 5 atm. The provision of the cooked meat patty further comprises freezing the cooked meat patty. The freezing is carried out at a temperature below about −30° C.

### DETAILED DESCRIPTION OF THE PREFERRED EMBODIMENT

The process for preparing ice cream burger of the invention comprises the steps of: grinding meat, mixing the ground meat with wine and refined salt, and ripening the mixture(primary ripening); mixing the ripened meat with powdered cookie or bread crumb, skim milk powder, soybean protein, fructose, starch syrup or sugar alcohol, sweetened condensed milk, carrageenan and mulberry leave powder, and ripening the meat mixture(secondary mixture); putting the ripened meat mixture into a moulding machine to mould a burger patty, sterilizing and steaming the patty to prepare a patty for ice cream burger; and, spreading ice cream on a lower piece of burger bun, putting the patty for ice cream burger on the ice cream, spreading ice cream on the patty, and putting an upper piece of burger bun thereon to obtain ice cream burger.

In the process for preparing ice cream burger of the present invention, the meat for ice cream burger preferably includes, but not limited thereto, beef, chicken and pork, which is preferably contained in the patty in a weight ratio of 5 to 40 wt %. The wine is preferably contained in the patty in a weight ratio of 0.1 to 1 wt %, and the refined salt is preferably contained in the patty in a weight ratio of 0.01 to 1 wt %. The primary ripening is preferably carried out, but not limited thereto, at a temperature of 4 to 10° C. for 30 min to 3 hours. Optionally, to improve its taste, the meat mixed with the wine and refined salt may be further seasoned with conventional spice for roast meat, ripened and roasted, where the spice for roast meat is not specifically limited, and is preferably added to the meat in a weight ratio of 10 to 50 wt %, the ripening is preferably carried out at a temperature of 4 to 10° C. for 1 to 3 hours, and the roasting is preferably carried out for 1 to 5 min.

The powdered cookie or bread crumb is preferably contained in the patty in a weight ratio of 20 to 50 wt %, skim milk powder 0.001 to 25 wt %, soybean protein 0.001 to 30 wt %, fructose 5 to 25 wt %, starch syrup or sugar alcohol 0.001 to 20 wt %, sweetened condensed milk 5 to 30 wt %, carrageenan 0.001 to 2 wt %, and mulberry leave powder 0.001 to 2 wt %. In particular, mulberry leave powder prepared by the method disclosed in Korean Patent Appln. No. 99-32108, is preferably employed. The secondary ripening is preferably carried out, but not limited thereto, at room temperature for 30 to 60 min.

The sterilizing and steaming burger patty preferably includes, but not limited thereto, high-temperature sterilization, high-pressure sterilization, pasteurization, and high-temperature/high-pressure sterilization. The high-temperature/high-pressure sterilization is preferably carried out at a temperature of 100 to 130° C. under a pressure of 1 to 5 atm. The patties thus prepared are preferably cryopreserved until just before the use, more preferably, they are in a quick frozen state at a temperature of below −30° C. Further, the ice cream burger of the present invention may be topped with all sorts of fruit syrup, chocolate syrup, caramel syrup, etc. between ice cream and patty to improve the taste and visual effect. The ice cream burger may be frozen for distribution and preservation, preferably in a quick frozen state at a temperature of below −30° C.

In order to overcome the discord of taste and feeling between meat for hamburger and ice cream, the present inventor has deodorized and ripened meat for hamburger by employing wine and refined salt, and added skim milk powder, fructose, sweetened condensed milk, etc. to the patty. The ice cream burger employing the patty thus obtained successfully solved the problem of discord between meat and ice cream in terms of taste and feeling. Particularly, in order to prevent the falling-off in taste due to freezing, saccharides and carrageenan, a polysaccharide, are added in great quantities to the patty to attenuate the hardened nature of the patty.

The present invention is further illustrated in the following examples, which should not be taken to limit the scope of the invention.

### EXAMPLE 1

### Preparation of Patties for Ice Cream Burger

300 g of beef was ground in a size of 5 mm, mixed with 10 g of wine and 6 g of refined salt, and ripened by leaving to stand at 7° C. for 60 min. Then, the ripened meat was mixed with powdered cookie 200 g, skim milk powder 100 g, soybean protein 150 g, fructose 100 g, starch syrup 50 g, sweetened condensed milk 80 g, carrageenan 2 g and mulberry leave powder 2 g, and left again for 60 min at room temperature to be ripened. And then, the mixture was put into a moulding machine to mould round patties of 10 cm in diameter and 1 cm in thickness, and steamed at 121° C. for 30 min under a pressure of 2 atm to prepare patties for ice cream burger. The patties were quick frozen at a temperature of −30° C. to preserve before preparing ice cream burger.

### EXAMPLE 2

### PREPARATION OF ICE CREAM BURGER

Buns for ice cream burger was first prepared, and then, ice cream was spread in thickness of 2 cm on the lower bun, and one of the patties prepared in Example 1 was placed thereon. After topping 20 g of fruit syrup and 20 g of caramel syrup on top of the patty, ice cream was spread in thickness of 2 cm thereon, covered by the upper bun, and then, quick frozen at a temperature of −45° C. to prepare ice cream burger.

As clearly illustrated and demonstrated above, the present invention provides a process for preparing ice cream burger whose main ingredient is meat, and ice cream burger prepared by the process. The ice cream burger of the invention is prepared by the steps of grinding meat, mixing the ground meat with wine and refined salt, and ripening the mixture; mixing the ripened meat with powdered cookie, skim milk powder, soybean protein, fructose, starch syrup, etc., and ripening the meat mixture; steaming the meat mixture to prepare a patty for ice cream burger; and, placing ice cream and the patty between two burger buns. The invented ice cream burger provides improved acceptability by attenuating the hardened nature of the patty due to freezing by the addition of saccharides and carrageenan to the patty while overcoming the discord of taste and mouth feeling between meat and ice cream, which makes possible potential development of new favorite food for summer.

What is claimed is:

1. An ice cream burger comprising:
a pair of bread pieces;
a cooked meat patty placed between the pair of bread pieces; and
at least one layer of ice cream placed between the pair of bread pieces.

2. The ice cream burger of claim 1, wherein one layer of the ice cream is placed between the cooked meat patty and either of the pair of bread pieces.

3. The ice cream burger of claim 1, wherein two layers of the ice cream are placed on both sides of the cooked meat patty.

4. The ice cream burger of claim 1, wherein the at least one layer of the ice cream comprises one or more sublayers of ice cream, and wherein neighboring sublayers are of different kinds of ice cream.

5. The ice cream burger of claim 4, wherein the neighboring sublayers of the ice cream are of different colors.

6. The ice cream burger of claim 1, further comprising one or more layers of flavoring materials selected from the group consisting of fruit flavored syrup, caramel syrup and chocolate syrup, wherein the one or more flavoring layers are placed between the pair of bread pieces.

7. The ice cream burger of claim 1, wherein the bread pieces are hamburger buns or sandwich bread.

8. The ice cream burger of claim 1, wherein the meat patty comprises one or more meat components selected from the group consisting of beef, pork, chicken, turkey and lamb.

9. The ice cream burger of claim 1, wherein the meat patty has a thickness from about 0.5 cm to about 2 cm.

10. The ice cream burger of claim 1, wherein each ice cream layer has a thickness from about 0.5 cm to about 3.5 cm.

11. The ice cream burger of claim 1, wherein each ice cream layer has a thickness from about 1.5 cm to about 2.5 cm.

12. The ice cream burger of claim 1, wherein the meat patty comprises a saccharide and carrageenan.

13. The ice cream burger of claim 1, wherein the meat patty comprises one or more substances selected from the group consisting of saccharides, polysaccharides, agar gum, guar gum, locust bean gum, carrageenan, tara gum, gum arabic, ghatti gum, Khayagrandifolia gum, tragacanth gum, and karaya gum.

14. The ice cream burger of claim 1, wherein the meat patty comprises one or more substances selected from the group consisting of saccharides, polysaccharides, powdered cookie, bread crumb, powdered skim milk, soybean protein, fructose, starch, sugar alcohol, sweetened condensed milk, carrageenan and mulberry leave powder.

15. The ice cream burger of claim 1, wherein the meat patty comprises at least one meat component from about 5 wt % to about 40 wt % with reference to the total weight of the meat patty.

16. The ice cream burger of claim 1, wherein the meat patty comprises powdered cookie or bread crumb from about 20 wt % to about 50 wt % with reference to the total weight of the meat patty.

17. The ice cream burger of claim 1, wherein the meat patty comprises powdered skim milk from about 0.001 wt % to about 25 wt % with reference to the total weight of the meat patty.

18. The ice cream burger of claim 1, wherein the meat patty comprises soybean protein from about 0.001 wt % to about 30 wt % with reference to the total weight of the meat patty.

19. The ice cream burger of claim 1, wherein the meat patty comprises fructose from about 5 wt % to about 25 wt % with reference to the total weight of the meat patty.

20. The ice cream burger of claim 1, wherein the meat patty comprises starch or sugar alcohol from about 0.001 wt % to about 20 wt % with reference to the total weight of the meat patty.

21. The ice cream burger of claim 1, wherein the meat patty comprises sweetened condensed milk from about 5 wt % to about 30 wt % with reference to the total weight of the meat patty.

22. The ice cream burger of claim 1, wherein the meat patty comprises carrageenan from about 0.001 to about 2 wt % with reference to the total weight of the meat patty.

23. The ice cream burger of claim 1, wherein the meat patty comprises mulberry leave powder from about 0.001 wt % to about 2 wt % with reference to the total weight of the meat patty.

24. A method of preparing an ice cream burger, comprising:
providing a cooked meat patty;
providing a pair of bread pieces;
providing at least one layer of ice cream; and
sandwiching the cooked meat patty and the at least one ice cream layer with the bread pieces, thereby providing an ice cream burger.

25. The method of claim 24, wherein the provision of the at lest one ice cream layer comprises forming at least one layer of ice cream on either side of the bread pieces.

26. The method of claim 24, wherein the provision of the at lest one ice cream layer comprises forming at least one layer of ice cream on either side of the cooked meat patty.

27. The method of claim 24, further comprising forming at least one flavoring layer with one or more flavoring materials selected from the group consisting of fruit flavored syrup, caramel syrup and chocolate syrup, and wherein the flavoring layer is formed before the sandwiching.

28. The method of claim 24, further comprising freezing the ice cream burger.

29. The method of claim 28, wherein the freezing the ice cream burger is carried out at a temperature below about −30° C.

30. The method of claim 24, wherein the provision of the cooked meat patty comprises:
providing ground meat;
mixing the ground meat with one or more substances selected from the group consisting of saccharide, polysaccharides, powdered cookie, bread crumb, powdered skim milk, soybean protein, fructose, starch, sweetened condensed milk, carrageenan and mulberry leave powder;
shaping the resulting mixture into a raw meat patty; and
cooking the raw meat patty to provide a cooked meat patty.

31. The method of claim 30, further comprising aging the ground meat for a period from about 30 minutes to about 3 hours before the mixing with the one or more substances.

32. The method of claim 30, further comprising adding wine and salt to the ground meat before the mixing with the one or more substances.

33. The method of claim 30, wherein the cooking the raw meat patty is carried out with use of a method selected from the group consisting of high-temperature sterilization, high-pressure sterilization, pasteurization and high-temperature/high-pressure sterilization.

34. The method of claim 30, wherein the cooking the raw meat patty comprises steaming the raw meat patty at a temperature from about 100° C. to about 130° C.

35. The method of claim 30, wherein the cooking the raw meat patty comprises steaming the raw meat patty at a pressure from about 1 atm to about 5 atm.

36. The method of claim 30, wherein the provision of the cooked meat patty further comprises freezing the cooked meat patty.

37. The method of claim 36, wherein the freezing is carried out at a temperature below about −30° C.
